(19) United States
(12) Patent Application Publication
(10) Pub. No.: US 2006/0072347 A1
(43) Pub. Date: Apr. 6, 2006

(54) Air blower unit for inflatable body

(76) Inventor: Allan R. Ferraro, Attleboro, MA (US)

Correspondence Address: STEVEN N. FOX, ESQ., P.O. BOX 251, CANTON, MA, 02021, US

(21) Appl. No.: 11/032,678

(22) Filed: Jan. 10, 2005

Related U.S. Application Data
(60) Provisional application No. 60/535,960, filed on Jan. 12, 2004.
(60) Provisional application No. 60/621,826, filed on Oct. 25, 2004.

(51) Int. Cl. F21S 4/00

(52) U.S. Cl. 362/808

(57) ABSTRACT

The present invention is a device for inflating and displaying a decorative air permeable body such as a snowman or ghost. In one embodiment, the device comprises an external air blower unit in fluid communication with the decorative body. The air blower unit comprises a first housing having an air inlet port and a second housing engaged with the first housing to form an internal air cavity and an exhaust port. The device further comprises a motor unit engaged with the second housing. The motor unit comprising a motor extending outward of the second housing and a shaft portion extending into the internal cavity portion. The motor unit further comprising a cage portion disposed in the cavity portion and engaged with the shaft portion. The device further comprises a cover engaged with the second housing to substantially enclose the motor. The device further comprises first and second leg portion engaged with the first housing and cover, respectively to support the air blower unit on the ground. Operation of the motor unit causes the outside air to be continuously drawn into the cavity portion and out the exhaust portion to inflate the decorative body.

### REFERENCE TO RELATED APPLICATIONS

This application claims priority to U.S. Provisional Patent Application Ser. No. 60/535,960 filed on Jan. 12, 2004, now pending; and U.S. Provisional Patent Application Ser. No. 60/621,826 filed on Oct. 25, 2004, now pending; and each of which are hereby incorporated by reference into this specification in their entirety.

### BACKGROUND OF THE INVENTION

Many commercial devices have been developed for use in inflating a commercial sign or character. Such conventional devices are unsafe for consumers of mass-market goods, especially those goods used by a person that include an electrical connection or wires. Mass-market retailers do not typically accept goods that have not been certified by Underwriters Laboratories (UL). In recent years, mass-market devices for inflating air permeable characters such as a snowman or clown have become popular. One type of conventional device is described in U.S. Pat. No. 6,644,843 which employs a motor and fan disposed within an inflatable character to provide continuous air flow. Such conventional devices have several drawbacks. By way of example only, such conventional devices use a fan and motor unit that is disposed either under or within the inflatable character thereby leading to an inflatable character which will not stand erect by itself and have difficulty even with ropes. By way of further example only, such conventional devices are difficult to manufacture in compliance with UL standards, and to assemble, package and ship in a cost effective manner and are likewise cumbersome to deploy, use and/or store by the consumer.

### SUMMARY OF THE INVENTION

The present invention is an air blower device for inflating and displaying a decorative air permeable body such as a snowman or ghost. In one embodiment, the air blower unit comprises a first housing having an air inlet port and a second housing engaged with the first housing to form an internal air cavity and an exhaust port. The device further comprises a motor unit engaged with the second housing. The motor unit comprising a motor extending outward of the second housing and a shaft portion extending into the internal cavity portion. The motor unit further comprising a cage portion disposed in the cavity portion and engaged with the shaft portion. The device further comprises a cover engaged with the second housing to substantially enclose the motor. The device further comprises first and second leg portion engaged with the first housing and cover, respectively to support the air blower unit on the ground. Operation of the motor unit causes the outside air to be continuously drawn into the cavity portion and out the exhaust portion to inflate the decorative body. The device may further comprise an electrical cord connected to the motor and a plurality of light units disposed in the decorative body for illumination. The cover may comprise a channel co-extensive with the exhaust portion for protecting the electrical cord from the environment. Unlike conventional mass market devices, the air blower unit of the present invention provides a simple and cost effective safe way to continuously inflate and illuminate a decorative air permeable body.

### BRIEF DESCRIPTION OF THE DRAWINGS

The following description of the invention will be more fully understood with reference to the accompanying drawings in which:

FIG. 1 is a perspective view of the present invention showing an air blower unit in fluid communication with an decorative air permeable body by a connection sleeve;

FIGS. 2 and 3 are right and left perspective views of the air blower unit; respectively;

FIG. 4 is an exploded view of the air blower unit;

FIG. 5 is a side view of the air blower unit of the present invention showing a light harness or electrical cord passing thru the exhaust port and into a protective channel of the cover portion;

FIGS. 6 and 7 are enlarged perspective views showing a light harness or electrical cord passing thru the exhaust port and into the protective channel of the cover portion;

FIG. 8 is a top plan view of the first housing portion showing the addition of a water shield disposed above the air inlet portion;

FIG. 9 is a perspective view of the first housing portion showing the addition of a water shield disposed above the air inlet portion;

FIG. 10 is a side elevation view of the first housing portion showing the addition of a water shield disposed above the air inlet portion;

FIG. 11 is a rear view of the first housing portion;

FIG. 12 is a perspective view of the second housing portion showing the motor engaged to outer surface of the second housing and a shaft passing through a centrally opening, and a passage way disposed in a sidewall of the exhaust portion to receive the protective channel portion;

FIG. 13 is a top plan view of the second housing;

FIG. 14 is a side elevation view of the second housing showing the interior open cavity and the inside of the air intake portion;

FIG. 15 is a perspective cut-away view showing the external mounting portion disposed about the exhaust port and the connection sleeve fastened about the external mounting portion by a rope, string or hook and loop fastener.

FIG. 16 is a perspective view of an inflatable air permeable decorative body or character having a resilient loop or coiled spring disposed within a pocket about the perimeter of the base portion of the body, and disposed in a deployed position;

FIG. 17 is an illustration of the resilient loop in a normally deployed planar position and then twisted and folded into a collapsed position forming three concentric circles are folded about themselves;

FIG. 18 is a perspective of another embodiment of the air blower unit comprises two exhaust ports and to allow the connection of two air permeable bodies, or alternatively, a fabric sleeve “Y” shaped fabric sleeve having separate “tubes”)

FIG. 19 is a high level block diagram of the electronic circuitry of the present invention adapted to detect when a person is in close proximity to the air permeable body and/or passes through the archway, including sound and/or motion detection circuitry and generating in response thereto a sound, movement and/or light from the air permeable body or archway; and

FIGS. 20 and 21 are perspective views of a system having electronic circuitry and devices adapted to detect when a person is in close proximity to the air permeable body and/or passes through the archway, including sound and/or motion detection circuitry and generating in response thereto a sound, movement and/or light from the air permeable body or archway.

### DETAILED DESCRIPTION OF THE INVENTION

This application claims priority to U.S. Provisional Patent Application Ser. No. 60/535,960 filed on Jan. 12, 2004, now pending; and U.S. Provisional Patent Application Ser. No. 60/621,826 filed on Oct. 25, 2004, now pending; and each of which are hereby incorporated by reference into this specification in their entirety..

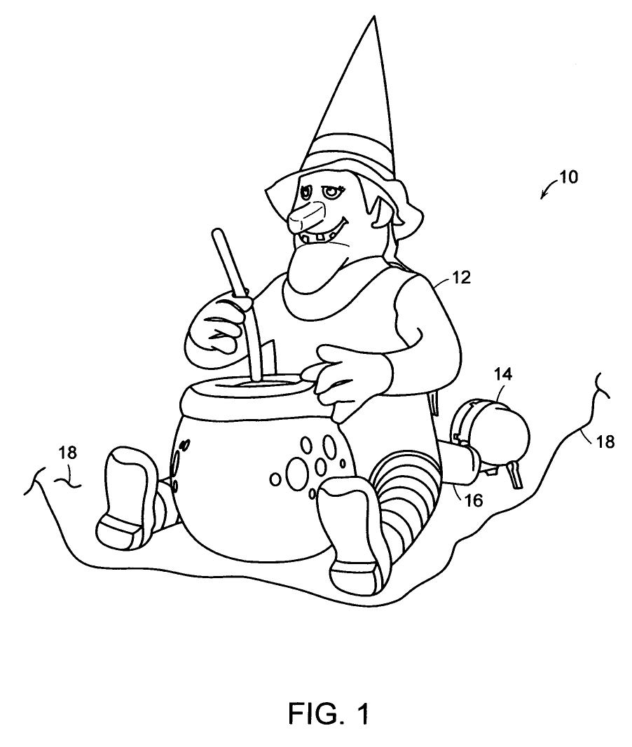

Referring to FIG. 1, the present invention is a mass market article or device 10 for inflating and displaying an inflatable character or body 12 such as a ghost or a snowman. The device 10 generally comprises an external air blower unit 14 in fluid communication with the body 12 by a connection sleeve 16 and supported on a support surface 18 such as the ground or if used indoors, a floor. Operation of the air blower unit 14 causes the outside air to be continuously drawn supplied to the body 12.

The body 12 may take a wide variety of shapes and sizes and is made from an air pervious material such that when fully inflated the body 12 will allow sufficient air to escape to off-set the outside air being continuously drawn into the body 12. In the embodiment shown, the body 12 is made from 170T Polyester or 190 Denier Nylon and may be fabricated by well known die-cutting, sonic welding and/or sewing operations. The connection sleeve 16 may be made from the same material as the body 12.

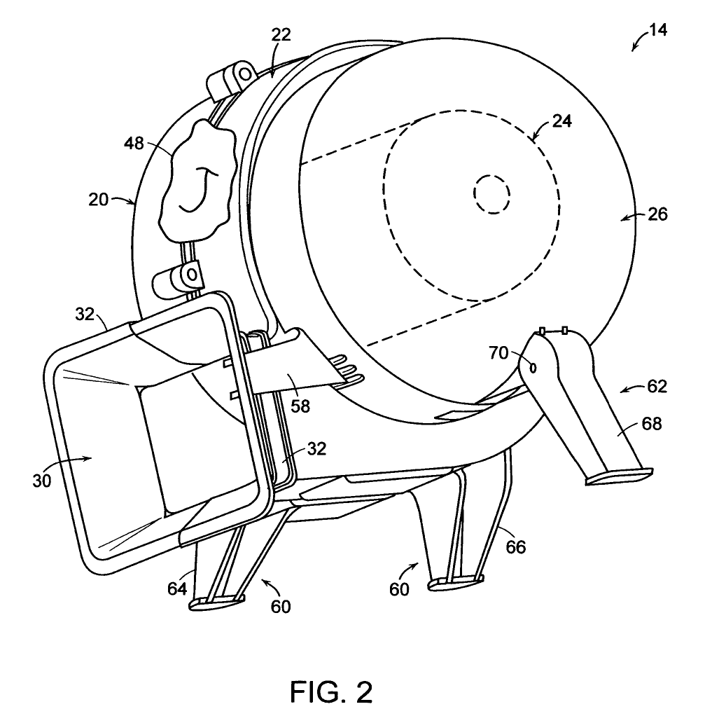

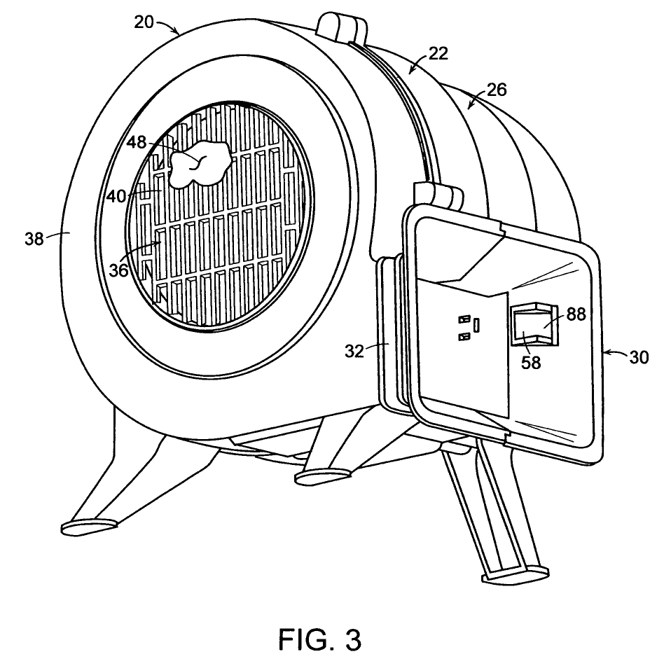

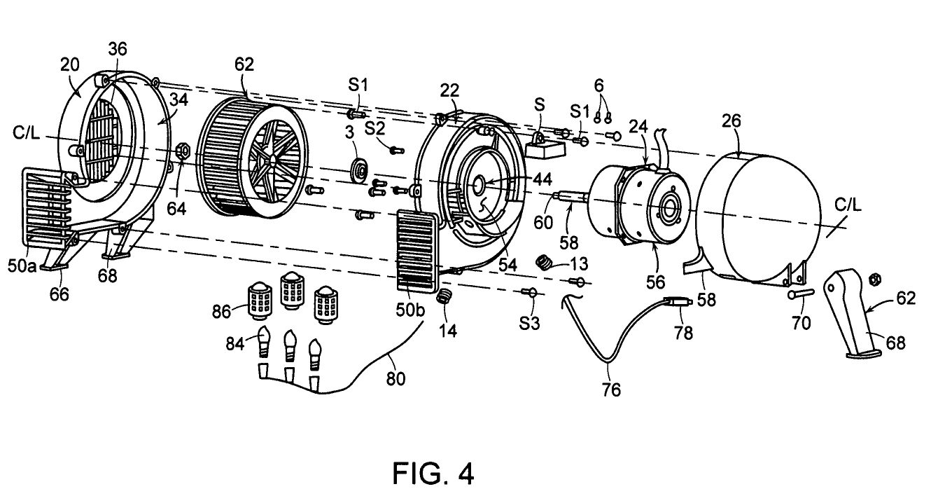

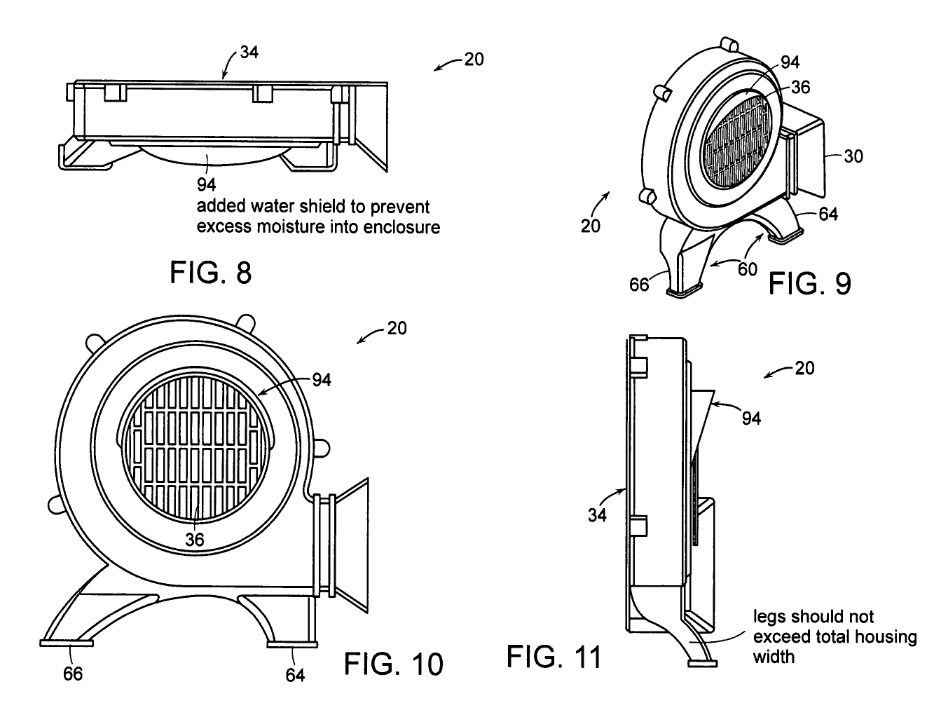

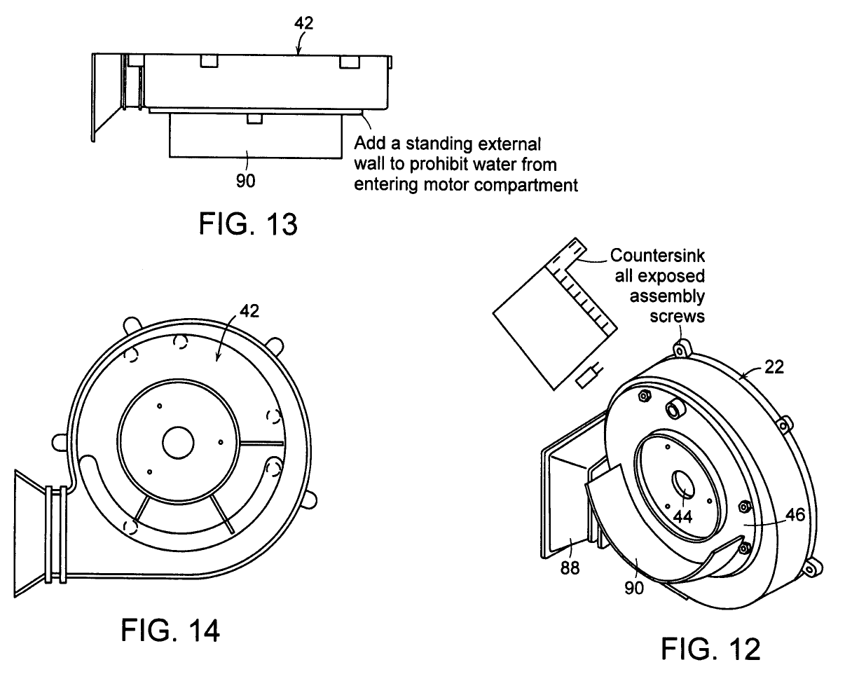

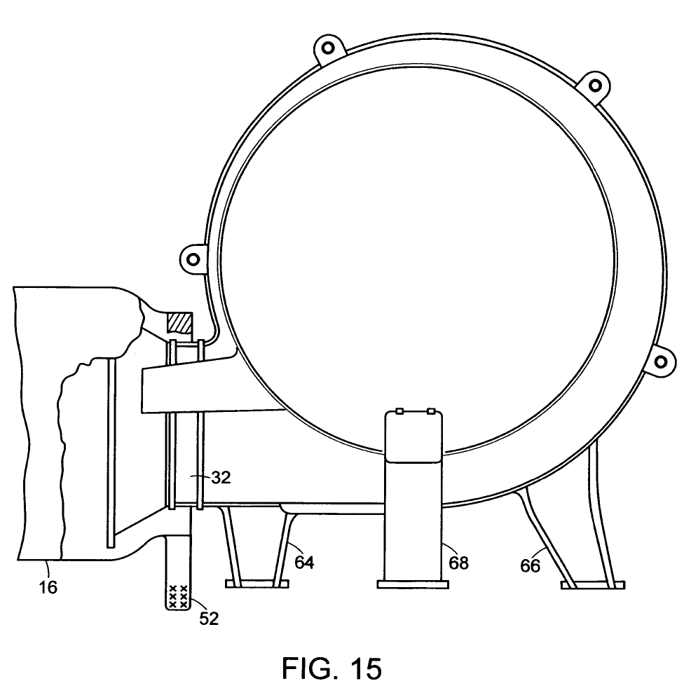

Referring to FIGS. 2-15, the air blower unit 14 generally comprises a first housing 20, a second housing 22, a motor unit 24, a cover 26. The air blower unit 14 further comprises a closed internal cavity portion 28, an exhaust portion 30, and an external mounting portion 32 each formed by engagement of the second housing 22 with the first housing 20. The first housing 20 generally comprises an open cavity portion 34 and an air inlet portion 36 disposed on a side 38 of the first housing 20. In the embodiment shown, the air inlet portion 36 comprises a plurality of spaced openings 40 in a mesh pattern and is formed as part of the first housing 20. The first housing 20 further comprises a water shield portion 94 disposed above the air inlet portion 36 to reduce the likelihood of water or other debris from entering the air inlet portion 36. The second housing 22 generally comprises an open cavity portion 42 and a centrally disposed opening 44 (FIGS. 3 and 12) on a side 46 of the second housing 22. The second housing 22 further comprises an curved partial sidewall 90 extending outward from the outer surface 46. The upwardly extending sidewall 90 is provided to restrict water flow into the motor cavity (also the external “rib” above the “domed enclosure” is there to further restrict the water from entering the motor cavity). The closed internal cavity portion 48 is in fluid communication with the air inlet portion 36 and the exhaust portion 30. The exhaust portion 30 may comprise a grill portion 50. The external mounting portion 32 is disposed outside and about the exhaust portion 30 and is adapted to allow the end of the connection sleeve 16 to slide over the external mounting portion 32 and be secured thereto by a rope, string or a hook and loop fastener 52.

The motor unit 24 is engaged with an outside surface 54 of the second housing 22 and generally comprises a motor 56 extending outward of the outside surface 54 of the second housing 22 and a shaft portion 58 having an end portion 60 extending into the closed internal cavity portion 48. The motor unit 24 further comprising an impeller or a cage portion 62 disposed in the closed internal cavity portion 64 and engaged with the end portion 60 of the shaft portion 58 by conventional means such as a nut 64. The motor 56 has a power rating of about 51.1 watts for a body 12 having a height of about 6 feet and an average width ranging from 36.0 to 42.0 inches. A larger motor 56 may be used, for example, a 75.5 watts to an inflate a body having a height (volume) in the range of about 8 feet to 14 feet.

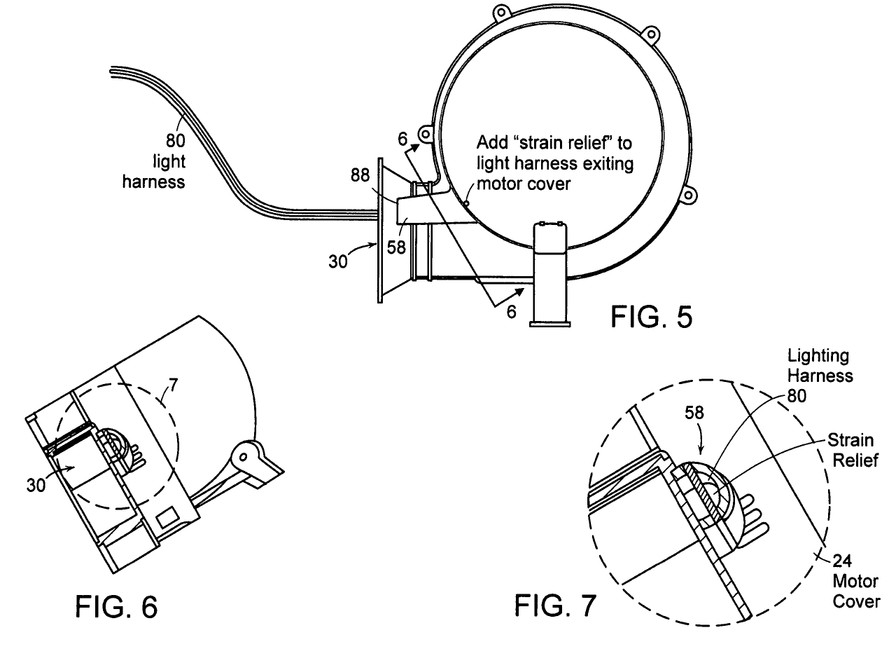

The cover portion 24 is engaged with the second housing 22 by conventional means such as bosses and screws to substantially enclose the motor 56. The cover portion 24 comprises a channel portion 58 which when engaged with the second housing 22 extends along a portion of the external mounting portion 32 into the exhaust portion 30. As shown by FIGS. 5-7, the channel portion 58 is provided to retain and protect an electrical light harness or cord 80 (to be described) extending from the motor 56 into the body 12. An opening or passage way 88 is provided in a sidewall 86 of the exhaust portion 30 to receive the end portion of the channel portion 58.

The air blower unit 14 further comprises first and second leg portions 60 and 62 adapted to support the air blower unit 14 on the ground 18. In the embodiment show, the first leg portion 60 comprises stationary first and second leg members 64 and 66 engaged with the first housing 20. The second leg portion 62 comprises a retractable first leg member 68 (a second member could be provided) rotatably engaged with the cover portion 24 about a shaft 70 from a stored or retracted position to a deployed position where along with the first and second leg members 64 and 66 operate to support the air blower unit 14 on the ground 18. The first and second stationary leg members 64 and 66, and retractable leg member 68 (when deployed) form a substantially triangular pattern to support the air blower unit 14 on the ground 18. The cover portion 24 comprises a flange portion 72 adapted to rotatable receive an end portion 74 of the leg member 68 about the shaft 70.

Each of the first and second housing portions 20 and 22, the cover portion 24 and the leg members 64, 66 and 68 may be made from well known polymer materials such as Acrylonitrile Butadiene Styrene (ABS)_ and polypropylene and fabricated by well known molding processes such as injection molding.

The longitudinal axis of the motor 56 is disposed substantially parallel to the ground 18 and a longitudinal centerline common to the longitudinal center line of the first housing 20, second housing 22, and the cover 24. The exhaust outlet 30 is disposed substantially perpendicular to the first and second stationary leg members 64 and 66. To provide power to the motor 56, an electrical cord or wire 76 having one end electrically connected to the motor 56 and a second end portion having a plug 78 adapted to electrically engage with an external power source such as wall outlet (not shown).

To provide illumination, the device 10 may comprise a second electrical cord or light harness 80 having a plurality of lamp holders 82. The light harness 80 and lamp holders 82 are widely available. Each of the lamp holders 82 comprise a lamp 84 which is likewise widely available. A first end portion of the light harness 80 is electrically connected to the electrical source of the motor 56 (or a junction thereto) and a second portion having the lamp holders 82 and lamps 42 mounted therein are disposed within the body 12. The second portion of the light harness 80 may be connected to the interior of the body 12 by conventional means such as plastic hook loops and strings (not shown). In the embodiment shown, each of the lamps 84 have a rating of about 7 watts. A protective cover 86 is provided which is removably engaged with the lamper holder 82 and covers the lamp 42. The protective cover 86 generally comprises a cylindrical shaped body 88 having a plurality of air vents or openings 90 closely spaced and aligned in rows and columns. The lamps 84 may illuminate the same color or different colors. The protective cover 86 may be made from well known polymer materials such as ABS or polypropylene and fabricated by formed by well known molding processes such as injection molding to form an unitary substantially rigid protective cover 86 as described.

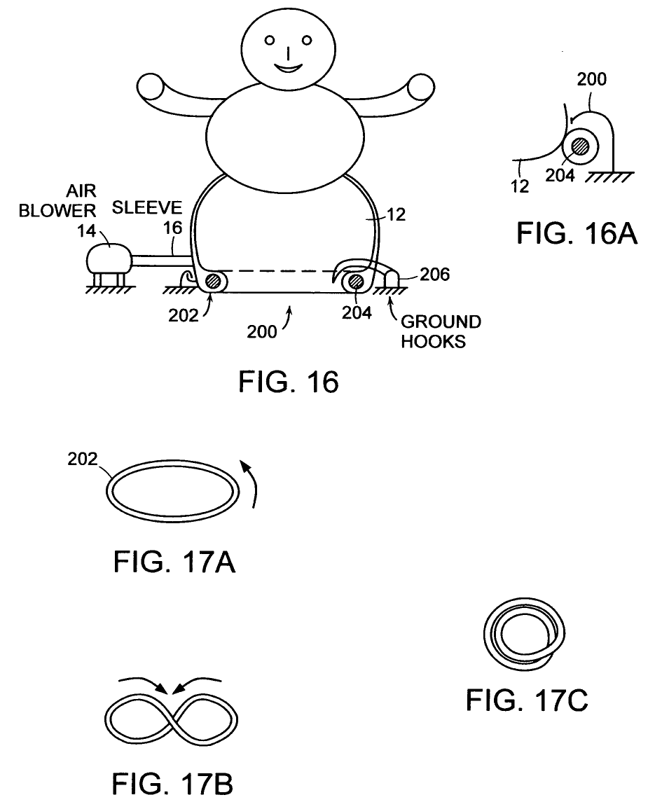

Referring to FIGS. 16 and 17, the device 10 may further comprise a wind and stability system 200 adapted to allow the device 10 to be used outdoors. The wind and stability system 200 comprises a resilient loop member 202 disposed within a pocket portion 202 at the perimeter of the bottom portion 204 of the body 12. The loop member 202 is preferably circular in shape thereby allowing the loop member 202 to be twisted and folded into three (3) smaller concentric circles. This twisting and folding method is well known in the art as, for example, taught by U.S. Pat. No. 6,073,283 to Zheng which is hereby incorporated by reference into this specification in its entirety. The loop member 202 provides a sturdy base structure for the body 12 and allows for self-erect opening of the bottom portion 204 of the body 12 by the person and for quick collapse and storage during non-use. Use of the loop member 202 allows the use of very large volume and tall body 12 while still maintaining stability. For still greater stability, a plurality of hook shaped stakes 206 may be provided which engage the loop member 202 to the ground. Alternatively, the wind stabilization system 200 may comprise a plurality of sand bags disposed at the bottom portion 204 and inside or outside of the body 12.

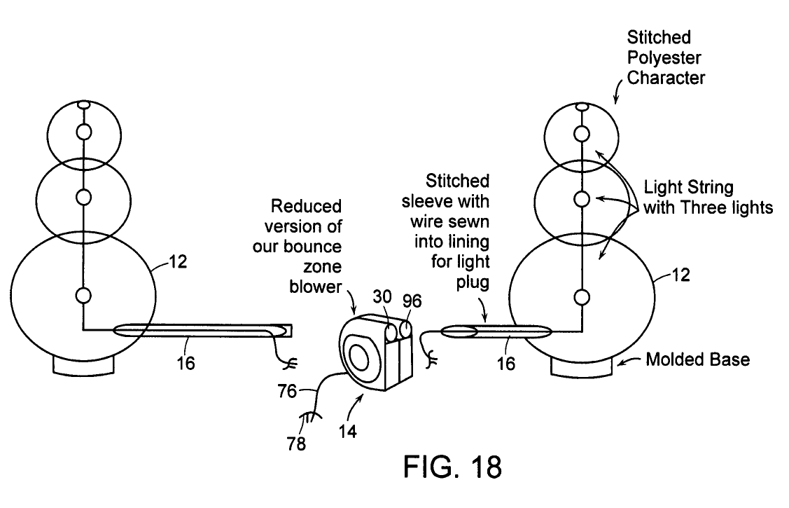

Referring to FIG. 18, the air blower unit may comprise exhaust port 30 and a second exhaust port 96. The air blower unit 14 of this embodiment allows two bodies 12 to be connected to the air blower unit 14 by connection sleeves 16.

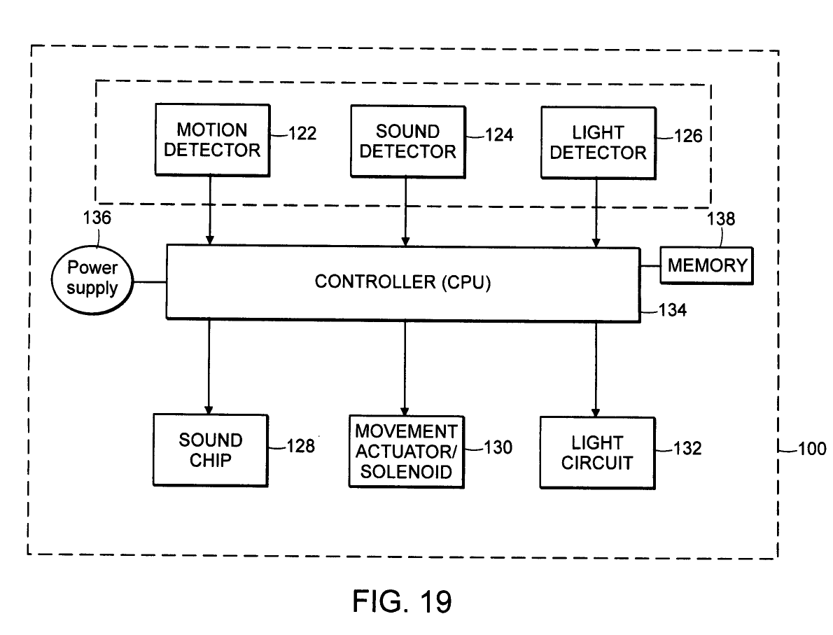

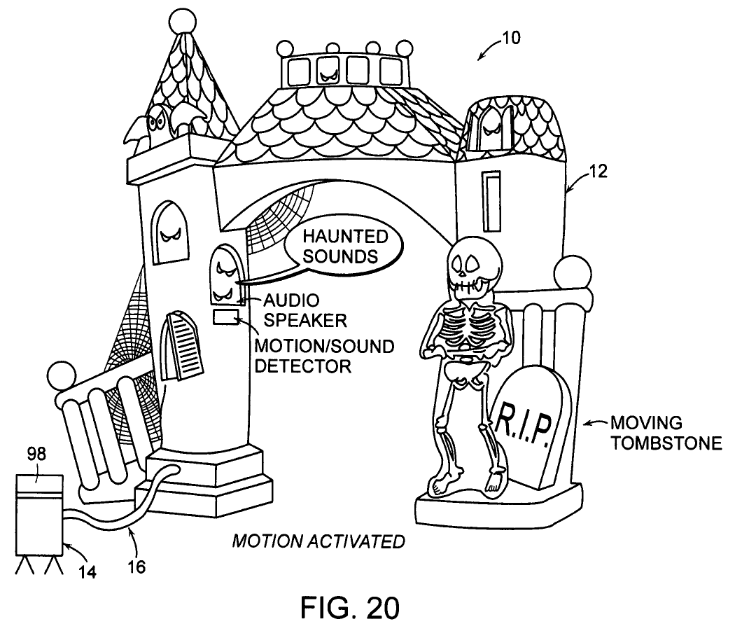

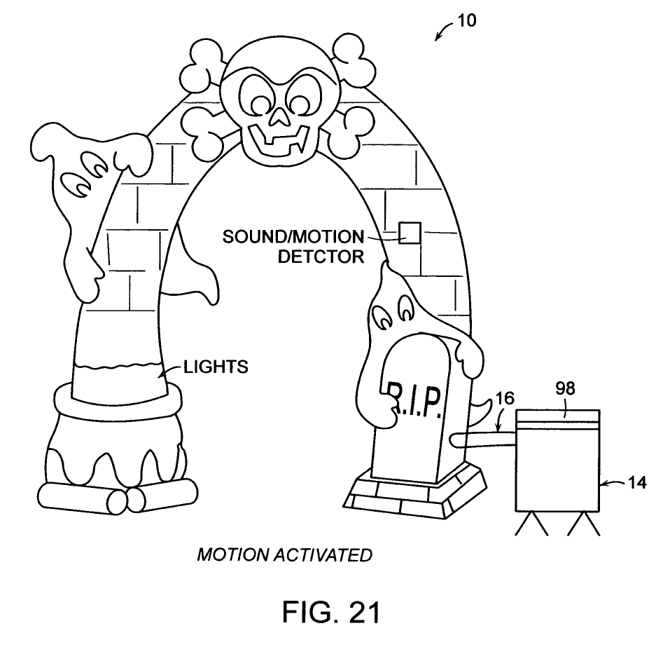

Referring to FIGS. 19-21, the device 10 may further comprise electronic circuitry 100 adapted to store and play one or more sounds from the body 12 and/or to control one of more lamps 84 in a still or animated manner. The electronic circuitry 100 may adapted to provide such sound and/or lights affects by a switch or a motion detector 122 and/or a sound detector 124, and/or a light detector 126. The electronic circuitry 100 may further comprises a sound chip 128 to record and play a first sound when prompted by a person or when the motion detector 122, sound detector 124 and/or light detectors 126 detects the motion, sound, and/or light. The electronic circuitry 100 may further comprise a light circuit 132 to output a signal to the lamps 84 to illuminate any one or different colors. The electronic circuitry 100 may further comprise a movement circuit 130 which outputs a signal to a solenoid to cause movement or motion of a feature of the body 12 such as a L tombstone when prompted by a person or when the motion detector 122, sound detector 124 and/or light detector 126 detects a motion, sound, and/or light. The electronic circuitry 100 may be disposed within the cover portion 24 or the body 12, or within a separate housing 98 engaged with the cover portion 24.

The device 10 may further comprises a remote control unit (not shown) adapted to activate the air blower unit 14 from a remote location such as inside a house (not shown).

The foregoing description is intended primarily for purposes of illustration. This invention may be embodied in other forms or carried out in other ways without departing from the spirit or scope of the invention.

What is claimed:

1. An inflatable device for use on a support surface and with outside air to inflate a decorative air impermeable body, the device comprising:
a first housing portion comprising an air inlet portion;
a second housing portion engaged with said first housing portion to form an internal cavity portion and an exhaust portion;
a motor unit engaged with said second housing; said motor unit comprising a motor extending outward of said second housing and a shaft portion extending into said internal cavity portion; said motor unit further comprising a cage portion disposed in said cavity portion and engaged with said shaft portion;
a cover portion engaged with said second housing portion and substantially enclosing said motor;
a first leg portion engaged with said first housing and adapted to rest on the support surface;
a second leg portion engaged with said cover portion and adapted to rest on the support surface; and
operation of said motor unit causes the outside air to be continuously taken in to said cavity portion and flow from said exhaust portion to inflate the decorate air impermeable body.

2. The device of claim 1, wherein second leg portion is rotatably engaged with said cover portion from a stored position to a deployed position.

3. The device of claim 2, further comprising a first electrical wire extending from said motor into said decorative air permeable body.

4. The device of claim 3, wherein said cover portion comprises a channel portion co-extensive with said exhaust portion and adapted to retain and protect said electrical wire passing from said cover portion to the decorative air permeable body.

5. The device of claim 4, wherein said motor is disposed substantially parallel to the ground.

6. The device of claim 5, wherein said exhaust outlet is disposed substantially perpendicular to said first and second leg portions.

7. The device of claim 6, wherein said first leg portion comprises first and second leg members engaged with said first housing and adapted to rest on the support surface.

8. The device of claim 7, wherein said second leg portion comprises first and second leg members engaged rotatably with said cover and adapted to rest on the support surface.

9. The device of claim 8, wherein said first, second and third leg members form a substantially triangular pattern to support the device on the support surface.

10. An inflatable device for use on a support surface and with outside air comprising:
a first housing portion comprising an air inlet portion;
a second housing portion engaged with said first housing portion to form an internal cavity portion and an exhaust portion;
a motor unit engaged with said second housing; said motor unit comprising a motor extending outward of said second housing and a shaft portion extending into said internal cavity portion; said motor unit further comprising a cage portion disposed in said cavity portion and engaged with said shaft portion;
a cover portion engaged with said second housing portion and substantially enclosing said motor;
a first leg portion engaged with said first housing and adapted to rest on the support surface;
a second leg portion engaged with said cover portion and adapted to rest on the support surface;
a decorative air permeable body engaged with said exhaust portion; and
operation of said motor unit causes the outside air to be continuously drawn into said cavity portion and out said exhaust portion to inflate said decorate air impermeable body.

11. The device of claim 10, wherein second leg portion is rotatably engaged with said cover portion from a stored position to a deployed position.

12. The device of claim 2, further comprising a first electrical wire extending from said motor into said decorative air permeable character.

13. The device of claim 12, wherein said cover portion comprises a channel portion extending into said exhaust portion adapted to protect said electrical wire from said motor to the decorative air permeable body.

14. The device of claim 13, wherein said motor is disposed substantially parallel to the ground.

15. The device of claim 14, wherein said first leg portion comprises first and second leg members engaged with said first housing and adapted to rest on the support surface.

16. The device of claim 15, wherein said second leg portion comprises first and second leg members engaged rotatably with said cover and adapted to rest on the support surface.

17. The device of claim 16, wherein said first, second and third leg members form a substantially triangular pattern to support the device on the support surface.
